(19) United States
(12) Patent Application Publication
(10) Pub. No.: US 2025/0335529 A1
(43) Pub. Date: Oct. 30, 2025

(54) ENHANCING WEB PAGE LOADING USING MACHINE LEARNING TECHNIQUES

(71) Applicant: Dell Products L.P., Round Rock, TX (US)

(72) Inventors: Vivek Bhargava, Bangalore (IN); David C. Sydow, Merrimack, NH (US); Dev Kathuria, Greater Noida (IN); Abhishek Mishra, Bangalore (IN)

(21) Appl. No.: 18/650,713

(22) Filed: Apr. 30, 2024

(51) Int. Cl. G06F 16/957; G06N 20/00

(52) U.S. Cl. CPC G06F 16/9574; G06N 20/00

(57) ABSTRACT

Methods, apparatus, and processor-readable storage media for enhancing web page loading using machine learning techniques are provided herein. An example computer-implemented method includes obtaining activity-related data associated with at least one user device and at least one web application during a web browsing session; generating one or more predictions of one or more web pages, associated with the at least one web application, to be sought in connection with the web browsing session by processing at least a portion of the activity-related data using one or more statistical algorithms and one or more machine learning techniques; and automatically preloading, in connection with the at least one web application, at least one of the one or more web pages for use in the web browsing session by the at least one user device.

### BACKGROUND

Speed and efficiency are important factors in determining user web browsing experiences. However, conventional web management techniques commonly introduce latency into the user experience in connection with acquiring data and/or page transitions, and can also incur higher infrastructure costs and maintenance over time with respect to managing web browsing sessions.

### SUMMARY

Illustrative embodiments of the disclosure provide techniques for enhancing web page loading using machine learning techniques.

An exemplary computer-implemented method includes obtaining activity-related data associated with at least one user device and at least one web application during a web browsing session. The method also includes generating one or more predictions of one or more web pages, associated with the at least one web application, to be sought in connection with the web browsing session by processing at least a portion of the activity-related data using one or more statistical algorithms and one or more machine learning techniques. Further, the method includes automatically preloading, in connection with the at least one web application, at least one of the one or more web pages for use in the web browsing session by the at least one user device.

Illustrative embodiments can provide significant advantages relative to conventional web management techniques. For example, problems associated with latency and higher infrastructure costs and maintenance are overcome in one or more embodiments through enhancing web page loading for user web browsing using machine learning techniques in conjunction with statistical analyses.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for enhancing web page loading using machine learning techniques in an illustrative embodiment.

FIG. 2 shows an example workflow across system architecture elements in an illustrative embodiment.

FIG. 3 shows an example data encoding table in an illustrative embodiment.

FIG. 4 shows an example Markov chain implemented in an illustrative embodiment.

FIG. 5 shows example system architecture of a bidirectional autoencoder long short-term memory (LSTM) neural network model in an illustrative embodiment.

FIG. 6 shows example user web browsing journey predictions with probability values for each web page level in an illustrative embodiment.

FIG. 7 is a flow diagram of a process for enhancing web page loading using machine learning techniques in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

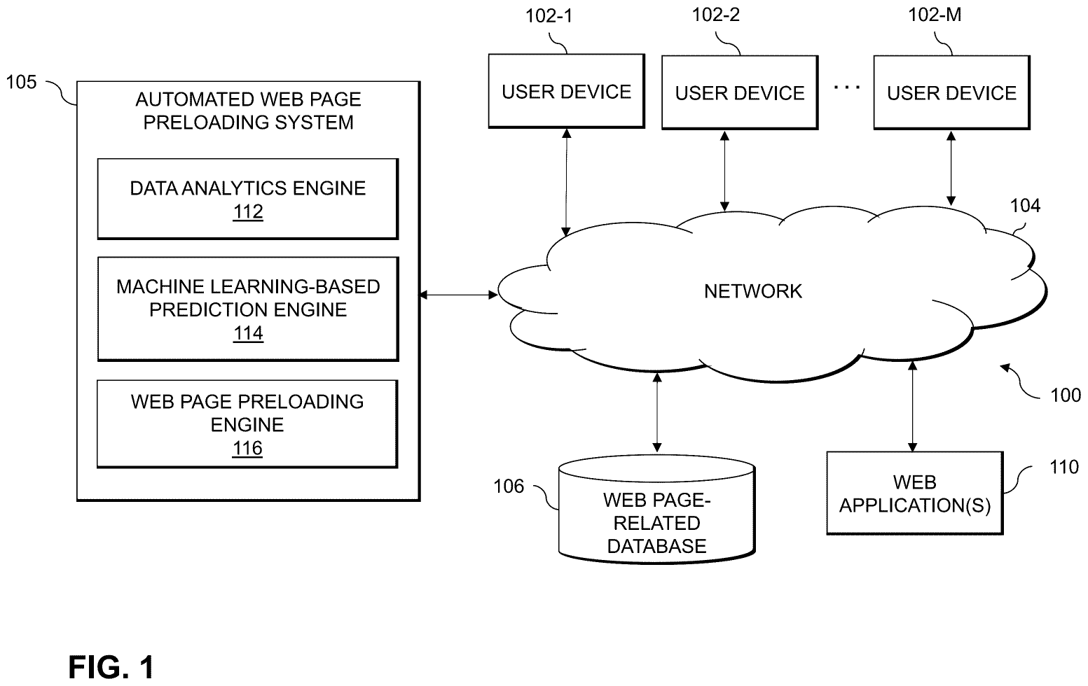

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated web page preloading system 105 and one or more web applications 110 (e.g., web applications utilized by one or more users during web browsing sessions and containing one or more distinct web pages therein).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated web page preloading system 105 can have an associated web page-related database 106 configured to store data pertaining to multiple web pages and corresponding websites and/or web applications, including data related to user activity patterns, data related to associations across web pages, etc.

The web page-related database 106 in the present embodiment is implemented using one or more storage systems associated with the automated web page preloading system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated web page preloading system 105 are one or more input-output devices, which illustratively comprise keyboards, displays or other types of input-output devices in any combination. Such input-output devices can be used, for example, to support one or more user interfaces to the automated web page preloading system 105, as well as to support communication between the automated web page preloading system 105 and other related systems and devices not explicitly shown.

Additionally, the automated web page preloading system 105 in the FIG. 1 embodiment is assumed to be implemented using at least one processing device. Each such processing device generally comprises at least one processor and an associated memory, and implements one or more functional modules for controlling certain features of the automated web page preloading system 105.

More particularly, the automated web page preloading system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated web page preloading system 105 to communicate over the network 104 with the user devices 102, and illustratively comprises one or more conventional transceivers.

The automated web page preloading system 105 further comprises data analytics engine 112, machine learning-based prediction engine 114, and web page preloading engine 116.

It is to be appreciated that this particular arrangement of elements 112, 114 and 116 illustrated in the automated web page preloading system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for enhancing web page loading using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated web page preloading system 105, web page-related database 106, and web application(s) 110 can be on and/or part of the same processing platform.

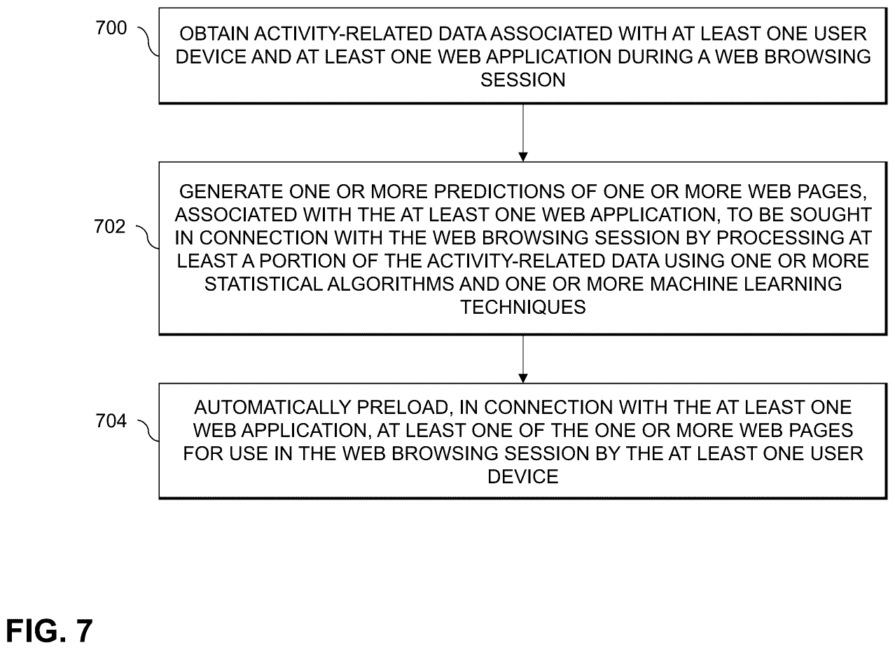

An exemplary process utilizing elements 112, 114 and 116 of an example automated web page preloading system 105 in computer network 100 will be described in more detail with reference to the flow diagram of FIG. 7.

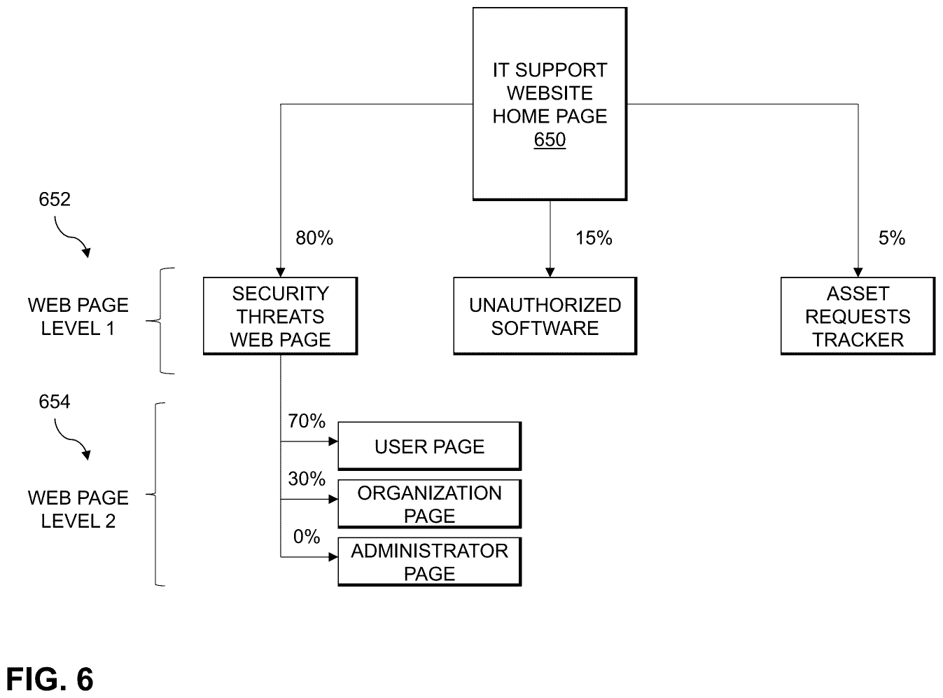

Accordingly, at least one embodiment includes generating and/or implementing a machine learning-based process to enhance and/or optimize web page loading. For example, such an embodiment includes enhancing a user's web browsing experience by providing efficient and/or instant web page navigation based at least in part on real time analysis of user behavior and leveraging at least one predictive model. More particularly, such an embodiment includes reducing and/or eliminating certain latencies and/or delays in web browsing experiences by predicting user actions based at least in part on processing real time user action data in conjunction with one or more historical data patterns. As used herein, a web page refers to a single document on a website that displays content and is accessed by a specific uniform resource locator (URL), whereas a website (also referred to herein as a web application) refers to a collection of related web pages. By way merely of example, as illustrated in the FIG. 6 embodiment, information technology (IT) support website home page 650 is a website/web application, and the web pages that the user can access in connection thereto can include, e.g., a security threats web page, an asset request tracker web page, etc.

Accordingly, the techniques detailed herein can include reducing user navigation time between individual web pages hosted within a single web site. One or more embodiments include implementing personalized orientations of web applications for users, as each user will follow a different navigation path based at least in part on their persona, previous patterns on the website, their current actions, etc. Also, a prediction and preloading mechanism will save users time when moving between web pages, and can provide a connected experience without loaders disrupting the user flow.

By way merely of illustration, consider a first example use case wherein a user notices, while on a given website, a delay whenever he or she clicks on a product to view details about the product. If the user has navigated to a website which displays various laptop models, an example embodiment can include determining that a majority of similar users select to view details about the model-X laptop, and accordingly, such an embodiment can include, during this web session, dynamically preloading at least portions of the web page containing model-X details.

By way of further illustration, consider a second example use case wherein a user is viewing articles related to patents on a given website. An example embodiment can include leveraging this user activity with one or more patterns determined in association with similar users, and dynamically preloading one or more web pages containing one or more other related articles which were accessed by at least a portion of the similar users.

By way of additional illustration, consider a third example use case wherein a user is learning and/or taking an educational course online on a given website. An example embodiment can include determining a likely sequence in which the user will navigate the educational course as per the curriculum and/or historical patterns associated with one or more other or similar users, and dynamically preloading one or more of the next web pages in the sequence. For instance, one or more embodiments can include determining that a user attempting to obtain a certain security certification requires completing multiple courses for which the user is registered. Such an embodiment can also include determining and/or identifying a pattern that other and/or similar users tend to complete those multiple courses in a particular order, and dynamically preloading the web pages associated with those multiple courses in accordance with the determined order of completion (e.g., dynamically prefetching the web page associated with the next course as and when the user completes the previous course in the order).

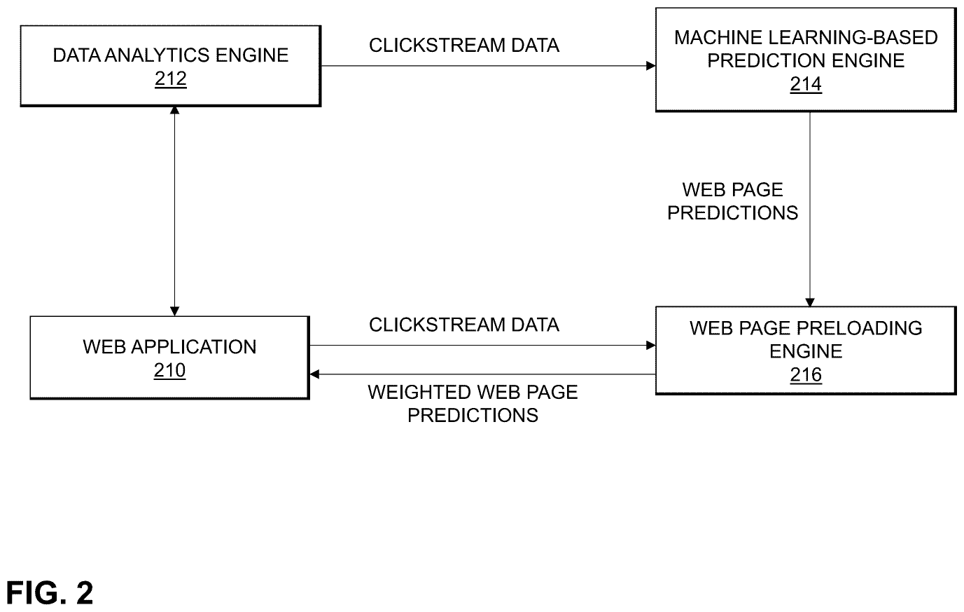

FIG. 2 shows an example workflow across system architecture elements in an illustrative embodiment. By way of illustration, FIG. 2 depicts system architecture elements which include a data analytics engine 212, responsible for collecting user activity data, a machine learning-based prediction engine 214, responsible for generating one or more web page-related predictions, and a web page preloading engine 216, responsible for using outputs from the machine learning-based prediction engine 214 to dynamically preload one or more web pages during a user web browsing session.

In at least one embodiment, data analytics engine 212 records and encodes clickstream data, associated with user activity in connection with web application 210, for use by machine learning-based prediction engine 214. As used herein, clickstream data includes a record of user activities on a website and/or web application which can be used, e.g., to identify one or more patterns. Particular clickstream parameters which can be collected in connection with one or more embodiments can include, for example, data identifying the current page, click location data, time spent on the web page, user role (e.g., on the application, such as administrator rights, etc.), user type (e.g., leader, manager, developer, etc.), user location, profile settings (e.g., do not disturb (DND), offline, focus mode, etc.), ping time, session time, current time, etc.

As also depicted in FIG. 2, machine learning-based prediction engine 214 processes at least a portion of the clickstream data provided by data analytics engine 212 and generates one or more predictions identifying one or more web pages which may be sought and/or accessed by the user in one or more future portions of the ongoing web browsing session in connection with web application 210. Such predictions generated by machine learning-based prediction engine 214 are output to and processed by web page preloading engine 216, in conjunction with real-time clickstream data from web application 210 to generate one or more weighted web page predictions. In such an embodiment, the weight refers to the probability of accessing a web page, wherein such probability can refer to the same prediction given by the machine learning-based prediction engine 214. The machine learning-based prediction engine 214 can provide multiple predictions with respective weights (referring to probability), and these weights can help the web application in prioritizing the preloading of resources. The web application 210 can prefetch the next given number of probable outcomes (sorted by weights) if the bandwidth allows. Referring again to FIG. 2, web page preloading engine 216 then outputs at least a portion of the one or weighted web page predictions to web application 210 to be used in connection with dynamically pre-fetching and/or preloading one or more corresponding web pages.

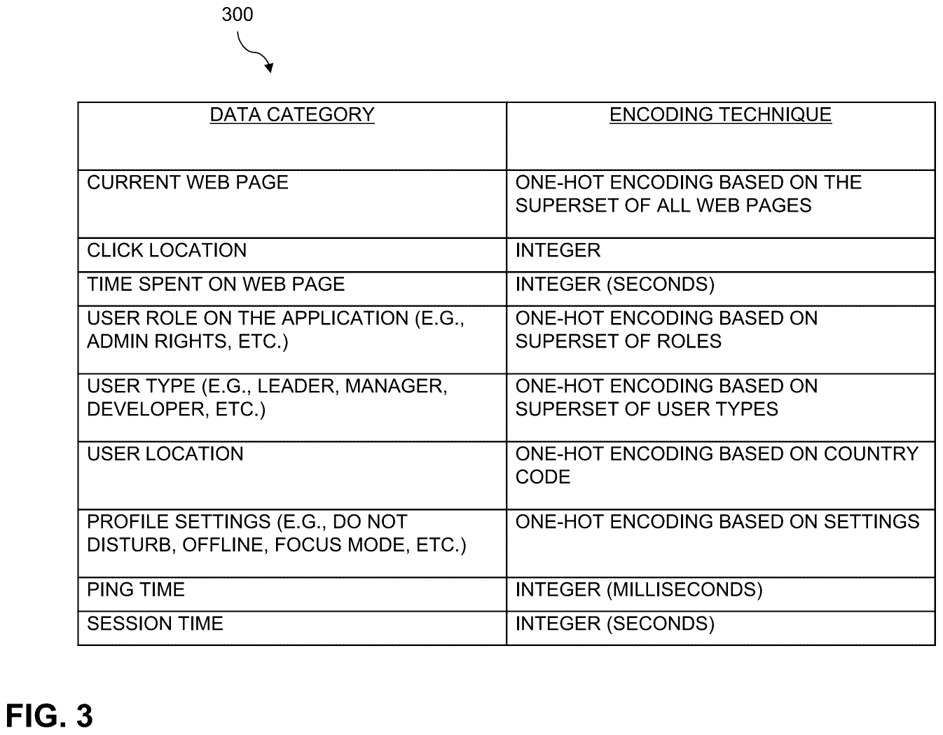

FIG. 3 shows an example data encoding table in an illustrative embodiment. By way of illustration, FIG. 3 depicts example data encoding table 300, which shows specific data encoding techniques used for each multiple types of data captured by a data analytics engine in connection with user web browsing activity. One or more embodiments include utilizing one hot encoding for categorical data (e.g., “current page,” “role,” “user type,” and “location”) that has no inherent ordinal relationship. By this representation, the model can treat each entity without assuming precedence or order. Additionally or alternatively, one or more embodiments can include utilizing integer encoding for numerical data representing quantity or count. Such data can include, e.g., click location represented by pixel coordinates on a website, time spent on a web page, and session time represented as duration in seconds.

In at least one embodiment, at least one machine learning-based prediction model is responsible for consuming and/or processing at least a portion of the data from the data analytics engine, and using such data to train and infer one or more applicable machine learning and statistical-based models in connection with the problem of pre-loading web pages. In such an embodiment, statistical analysis can be carried out using at least one discrete-time space first order Markov chain, which can enable predicting the next web page based on the previous web page.

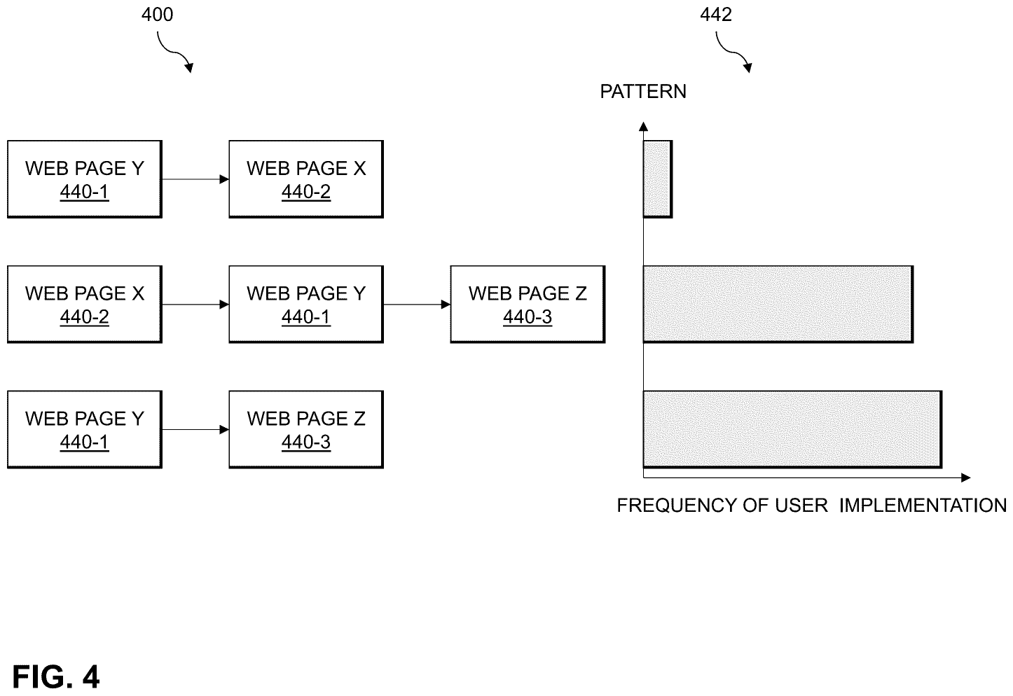

FIG. 4 shows an example Markov chain implemented in an illustrative embodiment. By way of illustration, FIG. 4 depicts an example Markov chain 400 with a corresponding probabilistic dependence of web page visits (across web page Y 440-1, web page X 440-2, and web page Z 440-3) wherein the example Markov chain 400 could be used. FIG. 4 represents an example wherein statistical inference can be an effective strategy using at least one Markov chain. In the example, the left side of the Figure (e.g., web pages 440-1, 440-2 and 440-3) represents patterns wherein users went from one web page to another, and the right side of the Figure represents a bar graph 442 indicating the number of users that followed that pattern. It can be seen for the first pattern (i.e., web page Y 440-1 to web page X 440-2), fewer users followed this pattern, whereas a larger number of users followed the second pattern (i.e., web page X 440-2 to web page Y 440-1 to web page Z 440-3) and the third pattern (i.e., web page Y 440-1 to web page Z 440-3). From the example depicted in FIG. 4, it can be derived that the possibility of the next web page is largely dependent on the current web page. For instance, if the user is at web page Y 440-1, at least one embodiment can include inferring that the user would next go to web page Z 440-3.

In one or more embodiments, training a Markov chain includes using the encoding of the “Current Page” field (as detailed in connection with FIG. 3) as the Y axis, and natural numbers as the X axis. Data can be bucketed, for example, by user role, user type, and/or user location, as also detailed in connection with FIG. 3. A unique Markov chain can be created for each of the various user roles, user types, and user location values. This will create an N× T×R matrix, with the values of N, T, and R represented by user roles, user type, and user location, respectively. Discrete visits for the same user role, user type, and/or user location occurring at different times can add new variables onto the end of the Markov Chain. Also, in at least one embodiment, training can be carried out at a given interval (e.g., on every 50,000 clickstream samples) to account for drift.

Additionally, in one or more embodiments, the input for inference of the Markov Chain is the current web page, and the output of the inference is the next web page(s) to be visited, along with a probability value attributed thereto.

Machine learning-based training and inference, in one or more embodiments, can be carried out using at least one multivariate time series fed into and/or processed by at least one bidirectional autoencoder LSTM neural network model. In such an embodiment, input variables to the training data can include information such as outlined in connection with FIG. 3, except for the “Current Page” variable, which will be treated as an output variable. By way of example, training data can encompass approximately 80% of the currently stored dataset, and testing data can encompass approximately 20% of the currently stored dataset, wherein the testing data set can include a contiguous sample within the overall dataset.

After the bidirectional autoencoder LSTM neural network model has been trained and run against the testing data, accuracy can be calculated using the resulting confusion matrix validated against the set of “Current Page” information in the dataset. Further, in at least one embodiment, model training and accuracy calculations can be re-run periodically (e.g., after every new 100,000 clickstream samples) to account for drift.

Additionally, the model input(s) for inference can include the information outlined in connection with FIG. 3 except for “Current Page,” as the output of the model will be a predicted value of “Next Page” (i.e., the next web page that the user will select and/or access). For example, the bidirectional autoencoder LSTM neural network model can process a list of times from T₀-T_{N}, with T_{N} representing the most recent web page that the user clicked on and/or selected. The LSTM will then predict T_{N+1}, which represents the next page that the model predicts the user will click on and/or select.

As noted above and herein, one or more embodiments include combining the use of statistical and machine learning algorithms. In such an embodiment, if at least one Markov chain is implemented in connection with a complex chain and is unable to predict with high confidence the next web page to be loaded, an inference can be run on an LSTM model to predict the next web page to be loaded, and both outputs can be considered in ultimately predicting the next web page that will be pre-loaded by a corresponding web application. To increase and/or maximize efficiency and reduce server load for predictions (and to reduce computational load), statistical inference can be performed prior to machine learning-based inference. If the probability returned from the statistical inference is higher than the corresponding machine learning-based inference accuracy value, then no machine learning-based inference will be used.

Accordingly, one or more embodiments include generating next web page predictions using both at least one Markov Chain and at least one bidirectional autoencoder LSTM neural network model in connection with specific data (such as outlined in connection with FIG. 3), and selecting at least one particular output based at least in part on accuracy and/or probability scores.

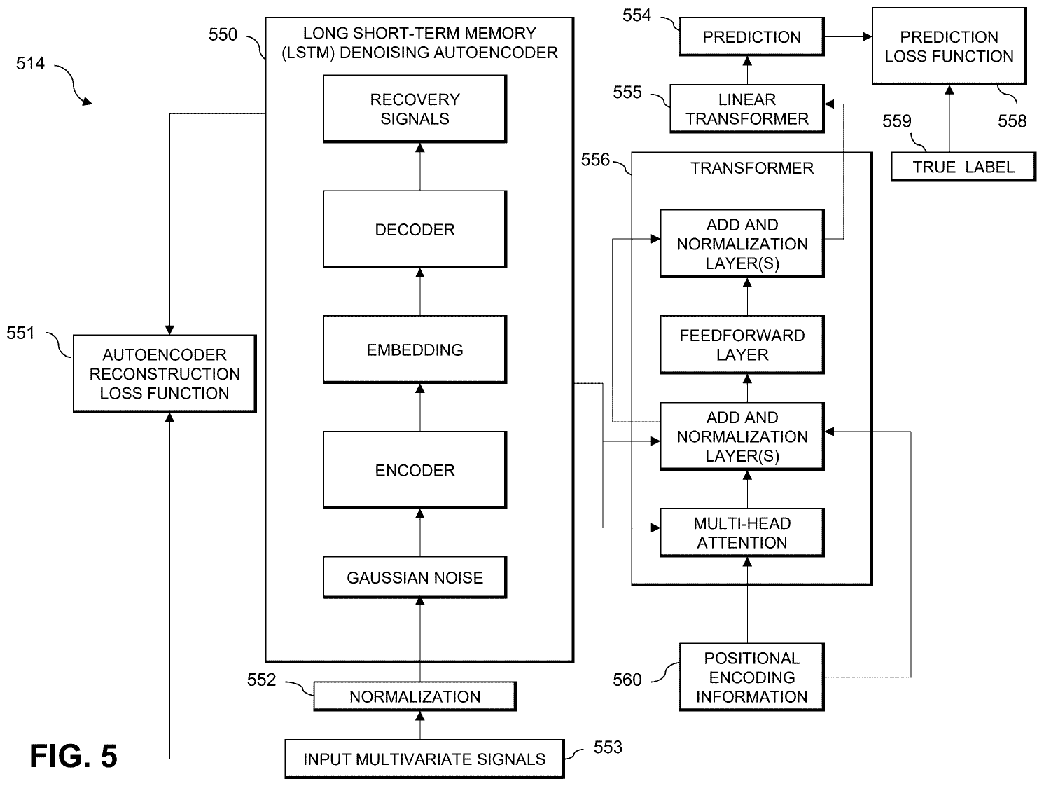

FIG. 5 shows example system architecture of a bidirectional autoencoder LSTM neural network model 514 in an illustrative embodiment. By way of illustration, FIG. 5 depicts input multivariate signals 553, which are provided to and/or processed by a normalization element 552 and an autoencoder reconstruction loss function element 551. The output(s) of the normalization element 552 is provided to and/or processed by LSTM denoising autoencoder 550, specifically by an encoder element in connection with Gaussian noise. Output(s) of the encoder element are then processed by an embedding element, at least a portion of the output of which is then processed by a decoder element. The output(s) of the decoder element includes one or more recovery signals, which are provided to and/or processed by autoencoder reconstruction loss function element 551.

As also depicted in FIG. 5, at least a portion of the output of the embedding element is processed, in connection with positional encoding information 560, by transformer 556 (which includes, e.g., multi-head attention, add and normalization layers, and a feedforward layer), and a linear transformer 555 to generate a prediction 554. The prediction 554 is then processed by prediction loss function 558 in connection with a corresponding true label 559.

Referring again to FIG. 2, in at least one embodiment, web page preloading engine 216 is responsible for the pre-fetching and loading of web pages in connection with web application 210 based at least in part on the feedback and/or output(s) of the machine learning-based prediction engine 214. In an example embodiment, such pre-fetching and loading of web pages can be carried out after every new clickstream action.

Accordingly, one or more embodiments include enhancing and/or optimizing multi-page web applications by performing link pre-fetching and server push techniques. Link pre-fetching refers to a browser mechanism which utilizes browser idle time to pre-fetch information that the user might need in the future. With every page load, a server implemented in accordance with one or more embodiments can append pre-fetching links to the document object mode (DOM) using, e.g., <link rel=“prefetch” />tag.

With respect to server push techniques, using HTTP/2 and/or one or more higher protocols, a server can preemptively push a web page to a given browser. In at least one embodiment, the backend server can directly consume data from the prediction server and push the prediction output to the user's browser for instant loading of the web page if the user visits the web page.

One or more embodiments can also include enhancing and/or optimizing single page applications (SPAs) using predictive data fetching. SPAs commonly rely on application programming interfaces (APIs) to fetch data for various web pages. In at least one embodiment, SPAs can prefetch and cache data for predicted web pages, and when the user goes to one of the predicted web pages, such an embodiment can include triggering and/or initiating an automatic background validation of the prefetched APIs and updating the data if there are changes. To further enhance such predictive prefetching, one or more embodiments can include maintaining at least one priority queue of API calls, with the highest weights attached to user-initiated actions followed by prediction-based API calls.

FIG. 6 shows example user web browsing journey predictions with probability values for each web page level in an illustrative embodiment. By way of illustration, FIG. 6 depicts an example prediction tree for a user who is currently on the IT support website home page 650. The prediction tree includes predictions for web pages across a first web page level 652 and a second web page level 654, along with probability values associated with each predicted web page.

The web pages depicted in the FIG. 6 example are within the context of an internal IT support tool associated with IT support website home page 650. In the FIG. 6 context, the web page levels (e.g., first web page level 652 and second web page level 654) refer to the movement(s) of a user from one web page to a next web page. For example, if the user goes to “Security Threats” web page in the first web page level 652, then the chances of the user going to the “User Page” in the second web page level 654 is the highest probability option (e.g., a 70% probability), but if the user takes a different path then the probabilities may change. By way of further example, if the user is on the IT support website home page 650, then the probability of the user going to the “Security Threats” web page in the first web page level 652 is 80%, but if the user was currently on the “Asset Requests Tracker” web page in the first web page level 652, then the probability of the user going to “Security Threats” web page in the first web page level 652 may produce different probabilities. In the example depicted in FIG. 6, the user has an 80% probability of going to the “Security Threats” web page in the first web page level 652, and if the user takes this path, out of the possible options in the second web page level 654, the user has the highest chance of going to the “User Page” and the lowest chance of going to the “Administrator Page.”

By pre-loading web pages and corresponding data, users can receive a smoother, uninterrupted user web browsing experience. Additionally, such user journeys can be personalized, wherein one or more embodiments include learning from user web browsing behavior and adapting future preloads accordingly. Further, implementation of one or more embodiments can result in reduced bounce rates, wherein faster web page load times can reduce user frustration, resulting in users being less likely to leave the website due to slow load times, leading to higher user retention.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on user action data within a current web browsing session as well as historical web browsing data, and such recommendations and/or predictions can be used to initiate one or more automated actions (e.g., automatically pre-fetching and/or pre-loading one or more web pages, automatically retraining the model using feedback related to the recommendations and/or predictions, etc.).

FIG. 7 is a flow diagram of a process for enhancing web page loading using machine learning techniques in an illustrative embodiment. It is to be understood that this particular process is only an example, and additional or alternative processes can be carried out in other embodiments.

In this embodiment, the process includes steps 700 through 704. These steps are assumed to be performed by the automated web page preloading system 105 utilizing elements 112, 114 and 116.

Step 700 includes obtaining activity-related data associated with at least one user device and at least one web application during a web browsing session. In at least one embodiment, obtaining activity-related data includes obtaining clickstream data associated with the at least one user device and the at least one web application during the web browsing session, wherein the clickstream data include one or more of data identifying a current web page, click location data, time spent on one or more web pages, web application rights associated with the at least one user device, user category associated with the at least one user device, user device location information, one or more user device profile settings, ping time data associated with the web browsing session, and temporal data associated with the web browsing session time.

Step 702 includes generating one or more predictions of one or more web pages, associated with the at least one web application, to be sought in connection with the web browsing session by processing at least a portion of the activity-related data using one or more statistical algorithms and one or more machine learning techniques. In one or more embodiments, generating one or more predictions of one or more web pages includes processing the at least a portion of the activity-related data using at least one bidirectional autoencoder LSTM neural network model. Additionally or alternatively, generating one or more predictions of one or more web pages can include processing the at least a portion of the activity-related data using at least one Markov chain.

Step 704 includes automatically preloading, in connection with the at least one web application, at least one of the one or more web pages for use in the web browsing session by the at least one user device. In at least one embodiment, generating one or more predictions of one or more web pages includes calculating a probability value attributed to each of the one or more predictions, and automatically preloading at least one of the one or more web pages includes selecting the at least one of the one or more web pages based at least in part on the probability value attributed to each of the one or more predictions.

In one or more embodiments, automatically preloading at least one of the one or more web pages includes pre-fetching and caching one or more APIs associated with the at least one of the one or more web pages using one or more SPAs. Additionally or alternatively, automatically preloading at least one of the one or more web pages can include preloading the at least one of the one or more web pages using one or more server push techniques. Further, in at least one embodiment, automatically preloading at least one of the one or more web pages can include pre-fetching information associated with the at least one of the one or more web pages during idle time in the web browsing session.

In one or more embodiments, the techniques depicted in FIG. 7 can also include automatically training at least a portion of the one or more machine learning techniques using feedback related to the one or more predictions.

Accordingly, the particular processing operations and other functionality described in conjunction with the flow diagram of FIG. 7 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to enhance web page loading for user web browsing using machine learning techniques. These and other embodiments can effectively overcome problems associated with latency and higher infrastructure costs and maintenance.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

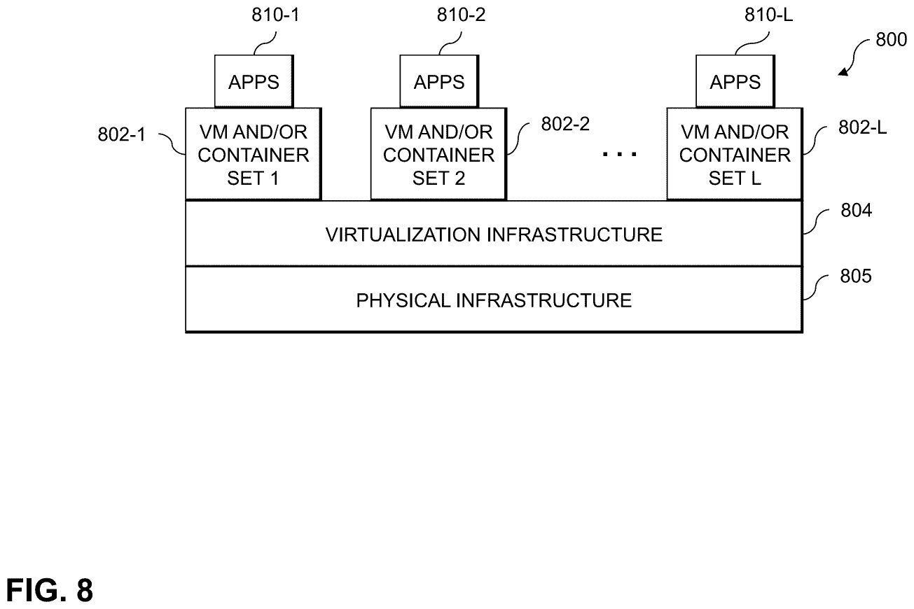

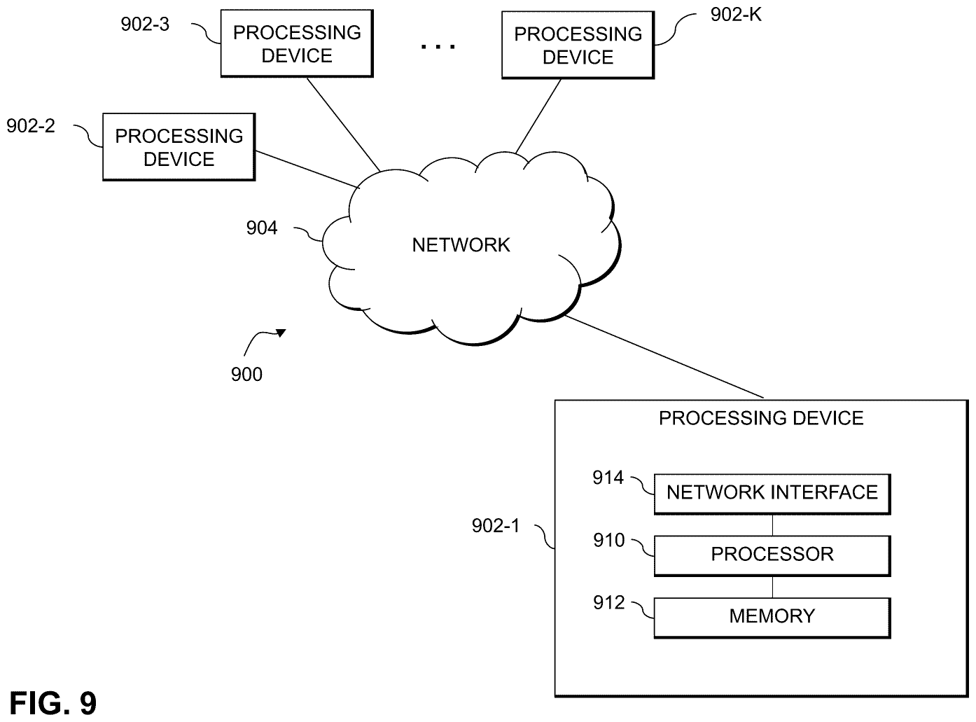

Illustrative embodiments of processing platforms will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that are utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 comprise respective VMs, respective sets of one or more containers, or respective sets of one or more containers running in VMs. In some implementations of the FIG. 8 embodiment, the VMs/container sets 802 comprise respective VMs implemented using virtualization infrastructure 804 that comprises at least one hypervisor.

A hypervisor platform may be used to implement a hypervisor within the virtualization infrastructure 804, wherein the hypervisor platform has an associated virtual infrastructure management system. The underlying physical machines comprise one or more information processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 902-1 in the processing platform 900 comprises a processor 910 coupled to a memory 912.

The processor 910 comprises a microprocessor, a CPU, a GPU, a TPU, a microcontroller, an ASIC, a FPGA or other type of processing circuitry, as well as portions or combinations of such circuitry elements.

The memory 912 comprises random access memory (RAM), read-only memory (ROM) or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining activity-related data associated with at least one user device and at least one web application during a web browsing session;
generating one or more predictions of one or more web pages, associated with the at least one web application, to be sought in connection with the web browsing session by processing at least a portion of the activity-related data using one or more statistical algorithms and one or more machine learning techniques; and
automatically preloading, in connection with the at least one web application, at least one of the one or more web pages for use in the web browsing session by the at least one user device;
wherein the method is performed by at least one processing device comprising a processor coupled to a memory.

2. The computer-implemented method of claim 1, wherein generating one or more predictions of one or more web pages comprises processing the at least a portion of the activity-related data using at least one bidirectional autoencoder long short-term memory (LSTM) neural network model.

3. The computer-implemented method of claim 1, wherein generating one or more predictions of one or more web pages comprises processing the at least a portion of the activity-related data using at least one Markov chain.

4. The computer-implemented method of claim 1, wherein generating one or more predictions of one or more web pages comprises calculating a probability value attributed to each of the one or more predictions, and wherein automatically preloading at least one of the one or more web pages comprises selecting the at least one of the one or more web pages based at least in part on the probability value attributed to each of the one or more predictions.

5. The computer-implemented method of claim 1, wherein automatically preloading at least one of the one or more web pages comprises pre-fetching and caching one or more application programming interfaces (APIs) associated with the at least one of the one or more web pages using one or more single page applications (SPAs).

6. The computer-implemented method of claim 1, wherein automatically preloading at least one of the one or more web pages comprises preloading the at least one of the one or more web pages using one or more server push techniques.

7. The computer-implemented method of claim 1, wherein automatically preloading at least one of the one or more web pages comprises pre-fetching information associated with the at least one of the one or more web pages during idle time in the web browsing session.

8. The computer-implemented method of claim 1, wherein obtaining activity-related data comprises obtaining clickstream data associated with the at least one user device and the at least one web application during the web browsing session, wherein the clickstream data comprises one or more of data identifying a current web page, click location data, time spent on one or more web pages, web application rights associated with the at least one user device, user category associated with the at least one user device, user device location information, one or more user device profile settings, ping time data associated with the web browsing session, and temporal data associated with the web browsing session time.

9. The computer-implemented method of claim 1, further comprising:
automatically training at least a portion of the one or more machine learning techniques using feedback related to the one or more predictions.

10. A non-transitory processor-readable storage medium having stored therein program code of one or more software programs, wherein the program code when executed by at least one processing device causes the at least one processing device:
to obtain activity-related data associated with at least one user device and at least one web application during a web browsing session;
to generate one or more predictions of one or more web pages, associated with the at least one web application, to be sought in connection with the web browsing session by processing at least a portion of the activity-related data using one or more statistical algorithms and one or more machine learning techniques; and
to automatically preload, in connection with the at least one web application, at least one of the one or more web pages for use in the web browsing session by the at least one user device.

11. The non-transitory processor-readable storage medium of claim 10, wherein generating one or more predictions of one or more web pages comprises processing the at least a portion of the activity-related data using at least one bidirectional autoencoder LSTM neural network model.

12. The non-transitory processor-readable storage medium of claim 10, wherein generating one or more predictions of one or more web pages comprises processing the at least a portion of the activity-related data using at least one Markov chain.

13. The non-transitory processor-readable storage medium of claim 10, wherein generating one or more predictions of one or more web pages comprises calculating a probability value attributed to each of the one or more predictions, and wherein automatically preloading at least one of the one or more web pages comprises selecting the at least one of the one or more web pages based at least in part on the probability value attributed to each of the one or more predictions.

14. The non-transitory processor-readable storage medium of claim 10, wherein automatically preloading at least one of the one or more web pages comprises pre-fetching and caching one or more APIs associated with the at least one of the one or more web pages using one or more SPAs.

15. The non-transitory processor-readable storage medium of claim 10, wherein automatically preloading at least one of the one or more web pages comprises preloading the at least one of the one or more web pages using one or more server push techniques.

16. An apparatus comprising:
at least one processing device comprising a processor coupled to a memory;
the at least one processing device being configured:
to obtain activity-related data associated with at least one user device and at least one web application during a web browsing session;
to generate one or more predictions of one or more web pages, associated with the at least one web application, to be sought in connection with the web browsing session by processing at least a portion of the activity-related data using one or more statistical algorithms and one or more machine learning techniques; and
to automatically preload, in connection with the at least one web application, at least one of the one or more web pages for use in the web browsing session by the at least one user device.

17. The apparatus of claim 16, wherein generating one or more predictions of one or more web pages comprises processing the at least a portion of the activity-related data using at least one bidirectional autoencoder LSTM neural network model.

18. The apparatus of claim 16, wherein generating one or more predictions of one or more web pages comprises processing the at least a portion of the activity-related data using at least one Markov chain.

19. The apparatus of claim 16, wherein generating one or more predictions of one or more web pages comprises calculating a probability value attributed to each of the one or more predictions, and wherein automatically preloading at least one of the one or more web pages comprises selecting the at least one of the one or more web pages based at least in part on the probability value attributed to each of the one or more predictions.

20. The apparatus of claim 16, wherein automatically preloading at least one of the one or more web pages comprises pre-fetching and caching one or more APIs associated with the at least one of the one or more web pages using one or more SPAs.
